(19) United States
(12) Patent Application Publication
(10) Pub. No.: US 2020/0363045 A1
(43) Pub. Date: Nov. 19, 2020

(54) Hands-Free Flashlight Device

(71) Applicant: Scott Reutter, Glendale, AZ (US)

(72) Inventor: Scott Reutter, Glendale, AZ (US)

(21) Appl. No.: 16/410,421

(22) Filed: May 13, 2019

(51) Int. Cl. F21V 21/40

(52) U.S. Cl. CPC F21V 21/406

(57) ABSTRACT

A flashlight carrying device for carrying a flashlight with a lighted end and cap end. The device has U-shaped tube body that can grip the flashlight. The U-shaped tube is attached to a solid body piece with a plurality of holes bored into the body. The holes would allow the fingers of a person to slide through the solid body to grip the device while the U-shaped tube that grips the flashlight rest on the top of the hand between the top knuckles of the fingers at a perpendicular angle to the fingers of the user.

### FIELD OF INVENTION

This invention relates generally to flashlight attachments, and more particularly, to a device that can transform an ordinary hand-held tubular flashlight into a hand-free flashlight.

### BACKGROUND OF INVENTION

Flashlights are a common and often necessary tool for many individuals in a variety of work or personal situations. Many flashlights comprise a generally tubular shape for enclosing batteries, with a light source on one end and a battery compartment cap on the other (referred to here as “tubular flashlights”). These flashlights are usually made from a variety of solid materials such as metals or plastics.

Tubular flashlights are designed to be hand-held. Tubular flashlights inherently force the user to hold the flashlight in one hand in order to use it. As a direct result, the user only has one hand left to perform a task. And by having to hold the flashlight, a user's hand is now subject to fatigue over time. This can be a problem for first responders, military and rescue personnel who would benefit greatly from the ability to use both hands while simultaneously holding a flashlight.

The present invention is designed to overcome such deficiencies.

### SUMMARY OF INVENTION

The present invention is a device for enabling hands-free use of a flashlight.

Aspects of the device comprise an elongated hollow body configured to connect to the body of a flashlight. The elongated body preferably comprises two open distal ends and an open apex portion. Aspects of the device also include a bottom section connected to a bottom length of the elongated hollow body, the bottom section comprising a plurality of holes oriented perpendicular to the elongated hollow body. The holes allow a user to hold the flashlight in a hands-free manner.

### BRIEF DESCRIPTION OF THE DRAWINGS

The accompanying drawings illustrate complete preferred embodiments of the present invention according to the best modes presently devised for the practical application of the principles thereof, and in which:

FIG. 1 is a perspective view of a preferred embodiment of the device;

FIG. 2 is a side view of a preferred embodiment of the device;

FIG. 3 is a front view of a preferred embodiment of the device.

FIG. 4 is a perspective view of a user using the device to hold a flashlight in a hands-free manner.

### DETAILED DESCRIPTION OF PREFERRED EMBODIMENTS

Example embodiments of the disclosure now will be described more fully hereinafter with reference to the accompanying drawings, in which example embodiments are shown. The concepts discussed herein may, however, be embodied in many different forms and should not be construed as limited to the example embodiments set forth herein; rather, these embodiments are provided so that this disclosure will be thorough and complete, and will fully convey the scope to those of ordinary skill in the art. Like numbers refer to like elements but not necessarily the same or identical elements throughout.

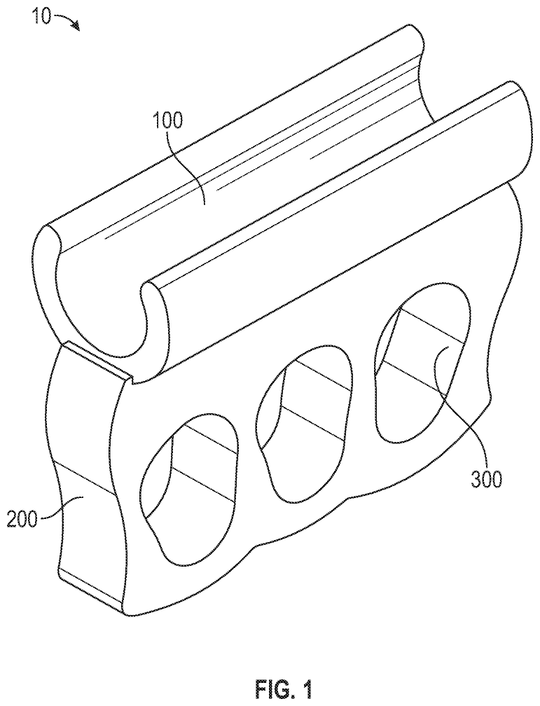

Referring to FIG. 1, an example device 10 is illustrated. The device 10 includes a tubular shaped portion 100 that would run parallel to a tubular flashlight. This tubular portion 100 is a hollow elongated body of a generally cylindrical shape, with two open distal ends.

Continuing with FIG. 1, the elongated body portion 100 is open along the mid-level line perpendicular to the length of the elongated body portion 100. The open top of the elongated body creates a cylindrical u-shaped tube that can hold a tubular flashlight when a user press-fits the tubular flashlight into the open top.

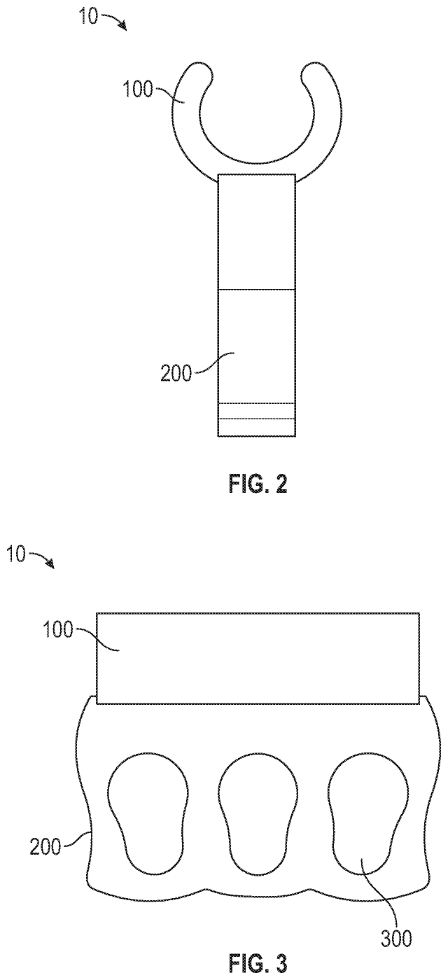

FIG. 2 illustrates the side view of the elongated body 100 and its u-shape. This elongated body 100 can be crafted with different lengths, radius and diameters to adhere to a variety of flashlight cross-sections.

It is preferred to make the elongated body portion 100 rigid, but flexible rubber-type material or similar substance which would allow the elongated hollow body to grip a flashlight, yet removable by hand. It is preferred to make the elongated body portion out of graphene plastic but those in the art could use other materials having similar material properties. The important characteristic are that the material be flexible enough to press a tubular flashlight into the open top while being rigid enough to hold the flashlight from falling out. Those in the art will recognize that many combinations of materials, sizes and rigidity could work with flashlights of varying sizes, including different lengths and diameters of the flashlight.

Those in the art will recognize that the elongated hollow body should be configured to the cross-sectional shape of the flashlight to be gripped. Thus, the elongated hollow body should be circular in shape for a circular flashlight, oval-shaped for an oval flashlight and square shaped for a square flashlight. Alternate embodiments of this elongated body 100 could have forms other than u-shaped, so long as there is a half-portion of the elongated body to grip the flashlight, especially flashlights that might have a different shape than the standard tube form.

Referring to FIG. 1 again, the elongated body portion 100 is connected to a solid body portion 200 to form one solid portion using plastic injection molding or similar process. In the preferred embodiment, elongated body portion 100 and the solid body portion 200 are formed as one piece. An alternate embodiment can have the elongated body 100 is rigidly connected to the solid body portion 200 so that the two pieces effectively become one piece. Those in the art will recognize that the two pieces could be joined by adhesive, welding or mechanically joining the two piece together. FIG. 2 shows this single fused piece between the flashlight grip tube 100 and the solid body piece 200. It is preferred to fuse the two pieces together by using the plastic injection molding or similar process. Alternately, the two could be separated using a means of attachment to engage and disengage the elongated body portion 100 from the solid body piece 200.

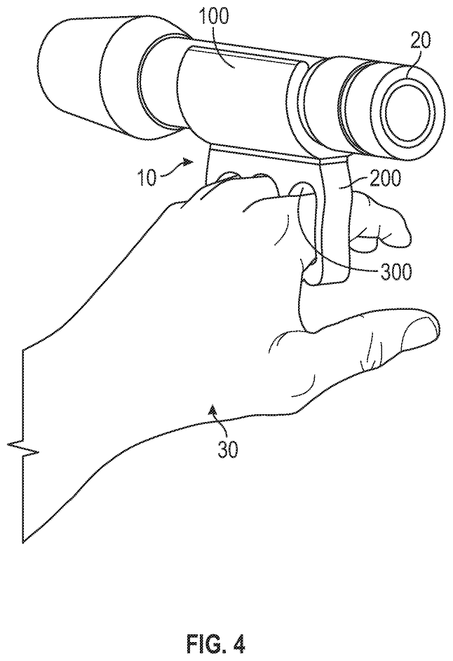

The preferred embodiment of this solid body part 200 should be a rubber-type flexible composite or similar like the flashlight grip 100. It is preferred to make the elongated body portion out of graphene plastic but many other similar materials can be used. Referring to FIG. 1 and FIG. 3, this solid body portion 200 will have a plurality of holes 300 through the frontal plane of the solid body piece 200. The proportions of the solid body 200 would be determined by the size of a person's hand in conjunction with the plurality of holes 300 that are bored into the solid body 200. Alternate embodiments can be smaller or larger to be compatible with a variety of people's hands.

Referring to FIG. 3, the plurality of holes 300 through the solid body piece 200 would preferably run perpendicular to the axis of length of the elongated body portion 100. This would allow a person to place several of their fingers from one hand into the holes 300, with the palm facing away from the flashlight as shown in FIG. 4. The fingers would run perpendicular to the axis of the flashlight grip 100. FIG. 4 shows the device 10 in use, with one embodiment of a flashlight 20 being gripped in the elongated body portion 100 while the fingers of the user's hand 30 slide through the holes 300 of the solid body portion 200, allowing the user's hand 30 to not have to grip the flashlight and be free to perform a variety of tasks. Such other tasks are practically limitless, but include things like holding other objects.

Preferably, this would allow the axis of the flashlight grip 100 to rest on the dorsal portion of the hand between the knuckles on the proximal phalanx of the fingers. This allows the person to utilize their fingers with more dexterity since gripping the flashlight is now alleviated. It is preferred the flashlight should rest on the top of the hand. But alternately, the light can be placed in the palm if necessary by inverting the position of the flashlight holding devise 10 from the top of the fingers, to the palm when placing the fingers of the user through the plurality of holes 300.

1. A device for holding a flashlight, the device comprising:
an elongated hollow body with two open distal ends and an open apex portion of the hollow body, the elongated hollow body comprising a bottom length, the bottom length oriented axially to the elongated hollow body; and,
a solid body bottom section rigidly connected to the elongate hollow body along the bottom length, the solid body bottom comprising a plurality of holes through the bottom section, each hole comprising a centerpoint and a face, the centerpoints of the plurality of holes oriented parallel to the bottom length and the faces of the plurality of holes oriented perpendicular to the bottom length;
wherein the elongated hollow body is configured to hold a flashlight and the plurality of holes configured to allow a user's fingers to pass through.

2. A method of using a device to hold a flashlight, the method comprising:
press-fitting a body of the flashlight into an elongated hollow body of the device, the elongated hollow body rigidly connected to a bottom section comprising a plurality of holes, each of the plurality of holes comprising a centerpoint and a face, the centerpoints oriented parallel to the bottom length and the faces of the plurality of holes oriented perpendicular to the bottom length;
inserting a user's fingers into the plurality of holes with the palm facing away from the body of the flashlight.
